(19) United States
(12) Patent Application Publication
(10) Pub. No.: US 2014/0370432 A1
(43) Pub. Date: Dec. 18, 2014

(54) Carrier Resins With Improved RH Sensitivity

(71) Applicants: National Research Council of Canada, Ottawa (CA); Xerox Corporation, Norwalk, CT (US)

(72) Inventors: Richard PN Veregin, Mississauga (CA); Qingbin Li, Edmonton (CA); Andriy Kovalenko, Edmonton (CA); Sergey Gusarov, Edmonton (CA); Daryl W. Vanbesien, Burlington (CA); Michael S. Hawkins, Cambridge (CA)

(21) Appl. No.: 13/917,666

(22) Filed: Jun. 14, 2013

(51) Int. Cl. G03G 9/113

(52) U.S. Cl. CPC G03G 9/1133
USPC 430/108.7; 430/111.1; 430/111.35; 430/111.32

(57) ABSTRACT

The instant disclosure describes acrylate-coated carrier resins exhibiting both high charge and improved RH sensitivity, carrier compositions comprising the acrylate coated carriers and developers comprising the carrier resins.

### FIELD

The instant disclosure relates generally to carrier resins, and to developers including such carrier resins, such as, acrylate carrier resins comprised of bulky groups comprising a tertiary carbon group which limits bulk water adsorption toward the resin, and particularly whereby the bulky tertiary carbon group limits water adsorption at the carbonyl group of said acrylate, which is the site of the electron donor which has the highest occupied molecular orbital (HOMO) electron density, thereby obtaining resins having both high charge and improved relative humidity (RH) sensitivity.

### BACKGROUND

The charging characteristics of a toner depend not only on the toner used but also on the carrier in a developer composition, such as, a carrier coating.

Toners having a triboelectric charging property within the range of about −30 μC/g and about −45 μC/g may be achieved when using smaller sized silica particles as external additives, for example silica particles having an average size of less than 20 nm, such as, for example, R805 (˜12 nm) and/or R972 (˜16 nm). However, developability at area of low toner area coverage degrades over time. That was attributed to the smaller-sized additives being impacted into the toner surface over time.

The problem with smaller-sized additives has been addressed by using larger-sized additives, i.e., additives having a size of 40 nm or larger, such as, for example, RX50 silica, RX515H silica or SMT5103 titania. However, although the impaction is addressed, the toners do not exhibit as high a triboelectric charging ability and also exhibit charge through.

Moreover, new carrier coatings are being developed that enable higher charging developers, particularly those with larger-sized additive package components. However, when such developers are tested at low area coverage followed by high area coverage, the developers tend to exhibit low or wrong sign toner due to charge through, i.e., the incumbent toner in the device becomes less negative or even wrong sign, i.e., positive, and the new (fresh) toner added may charge very negative. The presence of low charge and/or wrong sign toner can result in objectionable background.

There remain problems with providing high charge with good RH sensitivity of charge to changing environmental conditions for carrier coating resin designs. For example, there remains a requirement to be able to tune the charge of the carrier resin to produce higher charge for those situations where higher charge is required. It has not been possible to obtain both high charge and good RH sensitivity through a single design.

Further, tones often contain silica as a surface additive. Silica is considered a major charge driver for the toner and is RH sensitive. Thus, it is important to provide new carrier designs that work well with silica to improve RH sensitivity, while maintaining high charge.

### SUMMARY

The instant disclosure describes carriers and processes to prepare carriers, where the carrier is comprised of an acrylate resin exhibiting both high charge and improved RH sensitivity, including developers comprising said carriers.

In embodiments, a carrier composition is disclosed including a resin derived from at least one acrylate monomer comprising a bulky tertiary carbon group, where optionally, the monomer comprises a carbon:oxygen (C/O) ratio of at least 4.

A developer is disclosed comprising a methacrylate-coated carrier and a toner, where the carrier comprises a bulky tertiary carbon group, optionally, with a carbon:oxygen (C/O) ratio of at least 4, and where the toner comprises at least one silica surface additive.

In embodiments, a carrier of the present disclosure comprises a magnetic core and a polymeric coating over at least a portion of a surface of the core, the polymeric coating comprising optionally, a charge control agent, and optionally carbon black or another conductive additive, wherein the polymeric coating resin comprises at least one acrylate monomer comprising a bulky tertiary carbon group.

A process of the present disclosure comprises providing a carrier resin of interest as a powder and applying the powder coating to a core, which may be magnetic optionally treating said coated core, for example, applying pressure and/or heat thereto.

In embodiments, a method of designing carrier resins is disclosed including identifying a test polymer and modeling the surface of the polymer; identifying a test toner additive and modeling the surface of the toner additive; determining surface electron properties of the polymer and the toner additive using a density functional method, where the method determines structure calculations for local and gradient-dependent functions; determining the initial structure, optimized structure and electronic properties of adsorbed test polymer complexes on the toner additive; determining geometry optimization convergence for the adsorbed polymer complexes on the toner additive, where the optimization is achieved when the energy, gradient, and displacement are lower than about 2×10⁻⁵ Ha, about 4×10⁻³ Ha/Å, and about 5×10⁻³ Å, respectively, determining the likely direction of charge transfer between the polymer and toner additive by calculating the highest occupied molecular orbital (HOMO) and lowest unoccupied molecular orbital (LUMO) for the polymer-toner additive complexes; determining Fukui functions for surface electron densities in HOMO and LUMO to describe the active sites of the donor-acceptor complexes in charge transfer; and determining the lowest energy gap for both forward electron transfer and reverse electron transfer, where when the reverse gap is higher than the forward gap for the adsorbed polymer complexes on the toner additive, the negative gap difference is predictive of high negative toner charge in charging of toner resins comprising the polymer-toner additive complexes.

### DETAILED DESCRIPTION

The disclosure relates to carrier particles which include a core, in embodiments, comprised of a metal, with a resin, optionally, in combination with a conductive agent, such as, a carbon black, wherein the resin is comprised of a acrylate comprising a bulky tertiary carbon group which limits water adsorption at the carbonyl group of said acrylate, which is the site of the electron donor which comprises the HOMO electron density, thereby obtaining resins having both high charge and improved RH sensitivity.

In embodiments, a carrier composition is disclosed comprising a polymer coating resin comprising at least one acrylate monomer comprising a bulky tertiary carbon group, optionally, where the monomer comprises a carbon:oxygen (C/O) ratio of at least 4. The resins of interest are combined with carrier cores as known in the art to produce developers that can be used, for example, in imaging devices.

As used herein, the modifier, “about”, used in connection with a quantity is inclusive of the stated value and has the meaning dictated by the context (for example, it includes at least the degree of error associated with the measurement of the particular quantity). In embodiments, “about”, is interpreted to include values less than 10% from the stated metric. When used in the context of a range, the modifier, “about,” should also be considered as disclosing the range defined by the absolute values of the two endpoints. For example, the range, “from about 2 to about 4,” also discloses the range, “from 2 to 4.”

As used herein, “bulky tertiary carbon group,” means that there is at least one bulky tertiary symmetrical substituent and/or an asymmetrical substituent containing structure attached to a functional group. For example (but not so as to be limited), t-butyl methacrylate would contain a bulky tertiary structure attached to a carboxylate group, and thus, the tertiary butyl function would be included under the definition as a bulky tertiary carbon group.

By, “negative additives that are negatively chargeable to a reference carrier,” is meant that the additives are negatively charging relative to the toner surface measured by determining the toner triboelectric charge with and without the additive. Similarly, “by positive additives that are positively chargeable to a carrier,” is meant that the additives are positively charging relative to the toner surface measured by determining the toner triboelectric charge with and without the additive.

Negative additives that are negatively chargeable to a carrier include, for example, silica particles, titania particles, alumina particles or any small-sized particles (e.g., from about 7 to about 300 nm in volume average particle diameter as determined by any suitable technique) including, for example, polymeric microspheres, optionally treated with a composition rendering the particles negatively chargeable to a carrier or triboelectric contact therewith. The treating material may be, for example, a fluorosilane, for example a fluorosilane such as exemplified in U.S. Pat. No. 4,973,540, incorporated herein by reference in entirety, other halogen-containing organosilanes such as described in U.S. Pat. No. 5,376,172, incorporated herein by reference in entirety, silazanes, siloxanes and the like.

By, “RH sensitivity,” is meant a toner retains or comprises sufficient charge, particularly when exposed to higher humidity levels. The RH ratio is a useful metric for determining RH sensitivity. RH ratio generally is the ratio of charge, in μC/g, in the A zone to that in the C zone, where the A zone generally comprises 28° C. and 85% RH and the C zone generally comprises 12° C. and 15% RH. The Q/M charging RH ratio for the developer can be quantified as the ratio of the toner Q/M in A-zone to the toner Q/M in C-zone measured under otherwise similar conditions. The RH ratio can also be measured as the ratio of the toner charge Q/D in A-zone to the toner Q/D in C-zone. Thus, the RH ratio defined in those ways generally takes a value from 0 if the charge in A-zone is zero, to a value of 1, if the charge in both zones is the same. Thus, a value of 0.5 RH ratio of Q/M would indicate the Q/M charge in A-zone was one-half the value in C-zone. In some instances the value of the RH ratio might be larger than 1, indicating that charge in A-zone is higher than charge in C-zone when measured under otherwise similar conditions, though this is not common. An RH ratio could in some situations be negative, indicating that the sign of the charge also changes with the change in environmental zones, which is also uncommon. It should be noted that other environmental zones may be used instead of A-zone and C-zone to define the RH ratio of the developer.

### Carrier Resins

A carrier composition is disclosed comprising a polymer resin derived from at least one acrylate monomer comprising a bulky tertiary carbon group. In embodiments, the monomer can be depicted by the following formula, where R1 is H or methyl and R2 is a tertiary hydrocarbon:

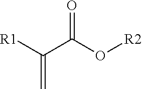

A tertiary hydrocarbon comprises, for example, t-butyl, t-hexyl, t-pentyl and the like.

In embodiments the acrylate monomer comprises a carbon:oxygen (C/O) ratio of at least 4.

The carrier resin may comprise a methacrylate monomer, having a T_{g} of between about 80° C. to about 140° C.

In embodiments, a bulky carbon group limits bulk water adsorption toward the resin, for example, reduces the water adsorption toward the HOMO electron density located on the carbonyl group of the acrylate, thus reducing the RH sensitivity to water adsorption. The bulky carbon group comprises tertiary structures, such as, a tertiary butyl (also known as 2-methylpropan-2-yl), a tertiary pentyl (also known as tertiary amyl or as 2-methylbut-2-yl), a tertiary hexyl (also known as 3-methylpent-2-yl), a tertiary heptyl (also known as 3-ethylpent-3-yl), a tertiary octyl (also known as 3-ethylhex-3-yl), a tertiary nonyl (also known as 4-ethylhept-4-yl), a tertiary decyl (also known as 4-n-propylhept-4-yl), and higher homologues containing a tertiary carbon. Thus, suitable monomers that can be used to prepare a suitable resin include, tertiary butyl methacrylate (also known as 2-methylpropan-2-yl methacrylate), or a tertiary pentyl methacrylate (also known as tertiary amyl methacrylate or as 2-methylbut-2-yl methacrylate), or a tertiary hexyl methacrylate (also known as 3-ethylpent-3-yl methacrylate), tertiary heptyl methacrylate (also known as 3-ethylpent-3-yl methacrylate), tertiary octyl methacrylate (also known as 3-ethylhex-3-yl methacrylate), tertiary nonyl methacrylate (also known as 4-ethylhept-4-yl methacrylate), tertiary decyl methacrylate (also known as 4-n-propylhept-4-yl methacrylate), and higher homologues with a tertiary carbon. Further suitable monomers that can be used to prepare a suitable resin include, tertiary butyl acrylate (also known as 2-methylpropan-2-yl acrylate), a tertiary pentyl acrylate (also known as tertiary amyl acrylate or 2-methylbut-2-yl acrylate), a tertiary hexyl acrylate (also known as 3-methylpent-2-yl acrylate), tertiary heptyl acrylate (also known as 3-ethylpent-3-yl acrylate), tertiary octyl acrylate (also known as 3-ethylhex-3-yl acrylate), tertiary nonyl acrylate (also known as 4-ethylhept-4-yl acrylate), tertiary decyl acrylate (also known as 4-n-propylhept-4-yl acrylate), and higher homologues with a tertiary carbon.

The resin further can further be prepared as a copolymer prepared from the bulky tertiary carbon acrylate monomer with a second monomer, including but not limited to a secondary amino acrylate monomer, an acidic monomer or other monomer used to control the charge of the prepared resin. Such secondary amino acrylate monomers include, but are not limited to, dimethylaminoethyl methacrylate, diethylaminoethyl methacrylate and diethylaminopropyl methacrylate. Suitable acidic acrylate monomers include, for example, acrylic acid, methacrylic acid, β-carboxyethyl acrylate, combinations thereof, and the like. The second monomer may be present from about 0.5 to about 1%, from about 1 to about 1.5%, from about 1.5 to about 2%, from about 2% to about 4% by weight of the polymer.

The resin may further be prepared as a copolymer prepared from the bulky tertiary carbon acrylate monomer with a second, or a third monomer if a charge control agent monomer is added, where the additional monomer is comprised of a primary acrylate, such as, methyl methacrylate or an aliphatic cycloacrylate. Suitable aliphatic cycloacrylates include, for example, methyl methacrylate, cyclohexyl methacrylate, cyclopropyl acrylate, cyclobutyl acrylate, cyclopentyl acrylate, cyclohexyl acrylate, cyclopropyl methacrylate, cyclobutyl methacrylate, cyclopentyl methacrylate, isobornyl methacrylate, isobornyl acrylate, combinations thereof, and the like.

In embodiments, the carrier resin polymer optionally may be copolymerized with any desired comonomer, so long as the resulting copolymer retains suitable charge transfer and RH sensitivity properties.

The carrier resins may be mixed in proportions of from about 30 to about 70 wt % to about 70 to about 30 wt %, from about 40 to about 60 wt % to about 60 to about 40 wt %. The coating may have a weight of, for example, from about 0.1 to about 5% by weight of the carrier, from about 0.5 to about 2% by weight of the carrier. Methods for forming the carrier particles are within the purview of those skilled in the art and include, in embodiments, coating the carrier core particles with the carrier polymer resin, including optionally a conductive agent.

In embodiments the resin can be prepared by emulsion polymerization of the monomers utilized to form a polymeric resin latex. In the emulsion polymerization process, the reactants may be added to a suitable reactor, such as, a mixing vessel. The appropriate amount of starting materials may be optionally dissolved in a solvent, an optional initiator may be added to the solution, and contacted with at least one surfactant to form an emulsion. A polymer or copolymer may be formed in the emulsion, which may then be recovered and used as the polymeric carrier resin.

Where utilized, suitable solvents include, but are not limited to, water and/or organic solvents, including toluene, benzene, xylene, tetrahydrofuran, acetone, acetonitrile, carbon tetrachloride, chlorobenzene, cyclohexane, diethyl ether, dimethyl ether, dimethyl formamide, heptane, hexane, methylene chloride, pentane, combinations thereof, and the like.

In embodiments, the latex for forming the polymeric carrier resin may be prepared in an aqueous phase containing a surfactant, optionally under an inert gas, such as, nitrogen. Surfactants which may be utilized with the resin to form a latex dispersion can be ionic or nonionic surfactants in an amount of from about 0.01 to about 15 weight percent of the solids, from about 0.1 to about 10 weight percent of the solids.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abietic acid available from Aldrich, NEOGEN R™, NEOGEN SC™ obtained from Daiichi Kogyo Seiyaku Co., Ltd., combinations thereof, and the like. Other suitable anionic surfactants include, in embodiments, DOWFAX™ 2A1, an alkyldiphenyloxide disulfonate from The Dow Chemical Co., and/or TAYCA POWER BN2060 from Tayca Corp., JP, which are branched sodium dodecyl benzene sulfonates. Combinations of the surfactants and any of the foregoing anionic surfactants may be utilized.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, C₁₂,C₁₅,C₁₇-trimethyl ammonium bromides, combinations thereof, and the like. Other cationic surfactants include cetyl pyridinium bromide, halide salts of quarternized polyoxyethylalkylamines, dodecylbenzyl triethyl ammonium chloride, MIRAPOL and ALKAQUAT available from Alkaril Chemical Co., SANISOL (Benzalkonium chloride), available from Kao Chemicals, combinations thereof, and the like. In embodiments a suitable cationic surfactant includes SANISOL B-50 available from Kao Corp., which is primarily a benzyl dimethyl alkonium chloride.

Examples of nonionic surfactants include, but are not limited to, alcohols, acids and ethers, for example, polyvinyl alcohol, polyacrylic acid, methalose, methyl cellulose, ethyl cellulose, propyl cellulose, hydroxyl ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, combinations thereof, and the like. Commercially available surfactants from Rhone-Poulenc such as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™ can be utilized.

The choice of particular surfactants or combinations thereof, as well as the amounts of each to be used, is within the purview of those skilled in the art.

In embodiments, initiators may be added for formation of the latex utilized in formation of the polymeric carrier resin. Examples of suitable initiators include water soluble initiators, such as ammonium persulfate, sodium persulfate and potassium persulfate, and organic soluble initiators including organic peroxides and azo compounds including Vazo peroxides, such as VAZO 64™, 2-methyl 2-2′-azobis propanenitrile, VAZO 88™, 2-2′-azobis isobutyramide dehydrate and combinations thereof. Other water-soluble initiators which may be utilized include azoamidine compounds, for example 2,2′-azobis(2-methyl-N-phenylpropionamidine) dihydrochloride, 2,2′-azobis[N-(4-chlorophenyl)-2-methylpropionamidine] di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylmethyl)propionamidine]dihydrochloride,2,2′-azobis[2-methyl-N-2-propenylpropionamidine]dihydrochloride, 2,2′-azobis[N-(2-hydroxy-ethyl)2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis (2-[1-(2-hydroxyethyl)-2-imidazolin-2-yl]propane)dihydrochloride, combinations thereof, and the like.

Initiators can be added in suitable amounts, such as from about 0.1 to about 8 weight percent, from about 0.2 to about 5 weight percent of the monomers.

In forming the emulsions, the starting materials, surfactant, optional solvent, and optional initiator may be combined utilizing any means within the purview of those skilled in the art. In embodiments, the reaction mixture may be mixed for from about 1 minute to about 72 hours, from about 4 hr to about 24 hr (although times outside these ranges may be utilized), while keeping the temperature at from about 10° C. to about 100° C., from about 20° C. to about 90° C., from about 45° C. to about 75° C., although temperatures outside those ranges may be utilized.

Those skilled in the art will recognize that optimization of reaction conditions, temperature, and initiator loading can be varied to generate polyesters of various molecular weights, and that structurally related starting materials may be polymerized using comparable techniques.

Once the polymer or copolymer utilized as the carrier resin has been formed, it may be recovered from the emulsion by any technique within the purview of those skilled in the art, including filtration, drying, centrifugation, spray drying, combinations thereof, and the like.

In embodiments, once obtained, the polymer or copolymer utilized as the carrier resin may be dried to powder form by any method within the purview of those skilled in the art, including, for example, freeze drying, optionally in a vacuum, spray drying, combinations thereof, and the like.

Particles of the polymer or copolymer may have a size of from about 40 nm to about 200 nm, from about 60 nm to about 120 nm.

In embodiments, if the size of the particles of the dried polymeric coating is too large, the particles may be subjected to homogenizing or sonication to further disperse the particles and break apart any agglomerates or loosely bound particles, thereby obtaining particles of the sizes noted above. Where utilized, a homogenizer, (that is, high shear device), may operate at a rate of from about 6,000 rpm to about 10,000 rpm from about 7,000 rpm to about 9,750 rpm, for a period of from about 0.5 min to about 60 min, from about 5 min to about 30 min, although speeds and times outside those ranges may be utilized.

The polymers and copolymers utilized as the carrier resin may have a number average molecular weight (Mₙ), as measured by gel permeation chromatography (GPC) of, for example, from about 60,000 to about 400,000, from about 170,000 to about 280,000, and a weight average molecular weight (M_{w}) of, fro example, from about 200,000 to about 800,000, from about 400,000 to about 600,000, as determined by GPC using polystyrene standards.

The polymers or copolymers may have a glass transition temperature (Tg) of from about 85° C. to about 140° C., from about 100° C. to about 130° C.

In some embodiments, the carrier coating may include a conductive component. Suitable conductive components include, for example, a colorant, such as, a black colorant, such as, a carbon black.

The resin is applied to a core in amounts and with methods known in the art.

### Toners

In embodiments, a developer is disclosed including an acrylate-coated carrier and a toner, where the toner may be, for example, an emulsion aggregation toner, containing, but not limited to, a latex resin, an optional wax, an optional colorant, and an optional polymer shell. However, any toner, no matter how prepared, can be used with a coated carrier of interest.

In embodiments, the latex resin may be composed of a first and a second monomer composition. Exemplary monomers for each of the first and/or the second monomer compositions include, but are not limited to, styrene, alkyl acrylate, such as, methyl acrylate, ethyl acrylate, butyl acrylate, isobutyl acrylate, dodecyl acrylate, n-octyl acrylate, 2-chloroethyl acrylate; β-carboxy ethyl acrylate (β-CEA), phenyl acrylate, ethyl α-chloroacrylate, methyl methacrylate, ethyl methacrylate and butyl methacrylate, butadiene, isoprene; methacrylonitrile, acrylonitrile; vinyl ethers, such as, vinyl methyl ether, vinyl isobutyl ether, vinyl ethyl ether and the like; vinyl esters, such as, vinyl acetate, vinyl propionate, vinyl benzoate, vinyl butyrate; vinyl ketones, such as, vinyl methyl ketone, vinyl hexyl ketone, methyl isopropenyl ketone and the like; vinylidene halides, such as vinylidene chloride, vinylidene chlorofluoride and the like; N-vinyl indole, N-vinyl pyrrolidene and the like; methacrylate, acrylic acid, methacrylic acid, acrylamide, methacrylamide, vinylpyridine, vinylpyrrolidone, vinyl-N-methylpyridinium chloride, vinyl naphthalene, p-chlorostyrene, vinyl chloride, vinyl bromide, vinyl fluoride, ethylene, propylene, butylene, isobutylene and the like, and mixtures thereof.

Other examples of such latex copolymers include poly(styrene-n-butyl acrylate-β-CEA), poly(styrene-alkyl acrylate), poly(styrene-1,3-diene), poly(styrene-alkyl methacrylate), poly(alkyl methacrylate-alkyl acrylate), poly(alkyl methacrylate-aryl acrylate), poly(aryl methacrylate-alkyl acrylate), poly(alkyl methacrylate), poly(styrene-alkyl acrylate-acrylonitrile), poly(styrene-1,3-diene-acrylonitrile), poly(alkyl acrylate-acrylonitrile), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylonitrile), poly(styrene-butyl acrylate-acrylononitrile), and the like.

Examples of other suitable resins or polymers which may be utilized include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), and poly(styrene-butyl acrylate-acrylonitrile-acrylic acid), and combinations thereof. The polymer may be block, random, or alternating copolymers.

The weight ratio between the first monomer composition and the second monomer composition may be generally in the range of from about 0.1:99.9 to about 50:50, from about 0.5:99.5 to about 25:75, from about 1.99 to about 10:90.

Other examples of the first/second monomer composition comprise styrene and alkyl acrylate, such as, a mixture comprising styrene, n-butyl acrylate and β-CEA. Based on total weight of the monomers, styrene may generally be present in an amount from about 1% to about 99%, from about 50% to about 95%, from about 70% to about 90%, although may be present in greater or lesser amounts; alkyl acrylate such as n-butyl acrylate may generally be present in an amount from about 1% to about 99%, from about 5% to about 50%, from about 10% to about 30%, although may be present in greater or lesser amounts.

The resins may be an amorphous resin, a crystalline resin, and/or a combination thereof. The polymer utilized to form the resin may be a polyester resin, including the resins described in U.S. Pat. Nos. 6,593,049 and 6,756,176, the disclosure of each of which hereby is incorporated by reference in entirety. Suitable resins may also include a mixture of an amorphous polyester resin and a crystalline polyester resin as described in U.S. Pat. No. 6,830,860, the disclosure of which is hereby incorporated by reference in entirety.

A, “crystalline polyester resin,” indicates one that shows not a stepwise endothermic amount variation but a clear endothermic peak in differential scanning calorimetry (DSC). However, a polymer obtained by copolymerizing the crystalline polyester main chain and at least one other component is also called a crystalline polyester if the amount of the other component is 50% by weight or less. To raise crystallinity, a polyester may comprise a straight chain dialcohol reagent in an amount of about 95% by mole or more, about 98% by mole or more.

In embodiments, the resin may be a polyester resin formed by reacting a diol with a diacid in the presence of an optional catalyst.

For forming a crystalline polyester, suitable diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol. 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethandiol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol may be, for example, selected in an amount of from about 40 to about 60 mole %, from about 42 to about 55 mole %, from about 45 to about 53 mole % (although amounts outside of those ranges can be used.

Examples of diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate or mixtures thereof. The diacid may be selected in an amount of, for example, from about 40 to about 60 mole %, from about 42 to about 52 mole %, from about 45 to about 50 mole %.

Examples of crystalline resins include polyesters, polyamides, polyimides, polyolefins, polyethlene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-aidpate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copolytethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount of from about 5 to about 50% by weight of the toner components, from about 10 to about 35% by weight of the toner components. The crystalline resin can possess various melting points of, for example, from about 30° C. to about 120° C., from about 50° C. to about 90° C. The crystalline resin may have a number average molecular weight (M_{g}), as measured by gel permeation chromatography (GPC) of, for example, from about 1,000 to about 50,000, from about 2,000 to about 25,000, and a weight average molecular weight (M_{w}) of, for example, from about 2,000 to about 100,000, from about 3,000 to about 80,000, as determined by GPC using polystyrene standards. The molecular weight distribution (M_{w}/Mₙ) of the crystalline resin may be from about 2 to about 6, from about 3 to about 4.

Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 52 mole percent of the resin, in embodiments from about 45 to about 50 mole percent of the resin. Examples of the alkylene oxide adducts of bisphenol include polyoxypropylene (2.2)-2,2-bis(4-hydroxyphenyl) propane, polyoxypropylene (3.3)-2,2-bis(4-hydroxyphenyl) propane, polyoxyethylene (2.0)-2,2-bis(4-hydroxyphenyl) propane, polyoxyethylene (2.2)-2,2-bis(4-hydroxyphenyl) propane, polyoxypropylene (2.0)-polyoxyethylene (2.0)-2,2-bis(4-hydroxyphenyl)propane, and polyoxypropylene (6)-2,2-bis(4-hydroxyphenyl)propane. The compounds may be used singly or as a combination of two or more thereof.

Examples of additional diols which may be utilized in generating the amorphous polyester include 1,2-propanediol, 1,3-propanediol, 1,2-butanediol, 1,3-butanediol, 1,4-butanediol, pentanediol, hexanediol 2,2-dimethylpropanediol, 2,2,3-trimethylhexanediol, heptanediol, dodecanediol, 1,4-cyclohexanedimethanol, 1,3-cyclohexanedimethanol, xylenedimethanol, cyclohexanediol, diethylene glycol, dipropylene glycol, dibutylene, and combinations thereof. The amount of organic diol selected can vary, and may be present, for example, in an amount from about 40 to about 60 mole % of the resin, from about 42 to about 55 mole % of the resin, from about 45 to about 53 mole % of the resin.

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole % based on the starting diacid or diester used to generate the polyester resin.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate), copoly(propylene-butylene-terephthalate)-copoly(propylene-butylene-5-sulfo-isophthalate), copoly(propoxylated bisphenol-A-fumarate)-copoly(porpoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), wherein the alkali metal is, for example, a sodium, lithium or potassium ion.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

Any suitable surfactant may be used for the preparation of latex and wax dispersions according to the present disclosure, such as those provided hereinabove in the discussion on carrier polymer resins. Surfactants may be employed in any desired or effective amount, for example, at least about 0.1% by weight of total monomers used to prepare the polymer, at least about 0.1% and generally no more than about 10% by weight of total monomers, no more than about 5%, although the amount can be outside of those ranges. Depending on the emulsion system, any desired nonionic or ionic surfactant such as anionic or cationic surfactant may be contemplated.

Examples of suitable anionic surfactants include, but are not limited to, sodium dodecylsulfate, sodium dodecylbenzene sulfonate, sodium dodecylnaphthalenesulfate, dialkyl benzenealkyl sulfates and sulfonates, abitic acid, NEOGEN R® and NEOGEN SC® available from Kao, Tayca Power®, available from Tayca Corp., DOWFAX®, available from Dow Chemical Co., and the like, as well as mixture thereof.

Examples of suitable cationic surfactants include, but are not limited to, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂,C₁₅,C₁₇-trimethyl ammonium bromides, halide salts of quarternized polyoxyethylalkylamines, dodecylbenzyl triethyl ammonium chloride, MIRAPOL® and ALKAQUAT® (available from Alkaril Chemical Co.), SANIZOL® (benzalkonium chloride, available from Kao Chemicals), and the like, as well as mixtures thereof.

Examples of suitable nonionic surfactants include, but are not limited to, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy)ethanol (available from Rhone-Poulene as IGEPAL CA-210®, IGEPAL CA-520®, IGEPAL CA-720®, IGEPAL CO-850®, IGEPAL CO-720®, IGEPAL CO-290®, IGEPAL CA-210®, ANTAROX 890® and ANTAROX 897®), and the like, as well as mixtures thereof.

An initiator or mixture of initiators may be used in the latex process and the toner process according to the present disclosure. In embodiments, the initiator is selected from various known free radical polymerization initiators, such as, those providing free radical species on heating to above about 30° C.

Although water soluble free radical initiators often are used, it is also within the scope of the present disclosure that other free radical initiators can be employed. Examples of suitable free radical initiators include, but are not limited to, peroxides, such as, ammonium persulfate, hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, sodium persulfate, potassium persulfate, diisopropyl peroxycarbonate, tetralin hydroperoxide, 1-phenyl-2-methylpropyl-1-hydroperoxide, tert-butylhydroperoxide pertiphenylacetate, tert-butyl performate, tert-butyl peracetate, tert-butyl perbenzoate, tert-butyl perphenylacetate, tert-butyl permethoxyacetate, and tert-butyl per-N-(3-toluyl)carbamate; azo compounds such as 2,2′-azobispropane, 2,2′-dichloro-2,2′-azobispropane, 1,1′-azo(methylethyl)diacetate, 2,2′-azobis(2-amidinopropane)hydrochloride, 2,2′-azobis(2-amidinopropane)-nitrate, 2,2′-azobisisobutane, 2,2′-azobisisobutylamide, 2,2′-azobisisobutyronitrile, methyl 2,2′-azobis-2-methylpropionate, 2,2′-dichloro-2,2′-azobisbutane, 2,2′-azobis-2-methylbutyronitrile, dimethyl 2,2′-azobisisobutyrate, 1,1′-azobis(sodium 1-methylbutyronitrile-3-sulfonate), 2-(4-methylphenylazo)-2-methylmalonodinitrile, 4,4′-azobis-4-cyanovaleric acid, 3,5-dihydroxymethylphenylazo-2-methylmalonodinitrile, 2-(4-bromophenylazo)-2-allylmalonodinitrile, 2,2′-azobis-2-methylvaleronitrile, dimethyl 4,4′-azobis-4-cyanovalerate, 2,2′-azobis-2,4-dimethylvaleronitrile, 1,1′-azobiscyclohexanenitrile, 2,2′-azobis-2-propylbutyronitrile, 1,1′azobis-1-chlorophenylethane, 1,1′-azobis-1-cyclohexanecarbonitrile, 1,1′-azobis-1-cycloheptanenitrile, 1,1′-azobis-1-phenylethane, 1,1′-azobiscumene, ethyl 4-nitrophenylazobenzylcyanoacetate, phenylazodiphenylmethane, phenylazotriphenylmethane, 4-nitrophenylazotriphenylmethane, 1′-azobis-1,2-diphenylethane, poly(bisphenol A-4,4′-azobis-4-cyanopentanoate), and poly(tetraethylene glycol-2,2′-azobisisobutyrate); and 1,4-bis(pentaethylene)-2-tetrazene, and 1,4-dimethoxycarbonyl-1,4-dipheny-1-2-tetrazene; and the like; and mixtures thereof.

Other free radical initiators include, but are not limited to, ammonium persulfate, hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, sodium persulfate, potassium persulfate, diisopropyl peroxycarbonate and the like.

Based on total weight of the monomers to be polymerized the initiator may generally be present in an amount from about 0.1% to about 5%, from about 0.4% to about 4%, from about 0.5% to about 3%, although an initiator may be present in greater or lesser amounts.

A chain transfer agent optionally may be used to control the polymerization degree of the latex, and thereby control the molecular weight and molecular weight distribution of the product latexes of the latex process and/or the toner process according to the present disclosure. As a skilled artisan can appreciate, a chain transfer agent often becomes part of the latex polymer

In embodiments, the chain transfer agent has a carbon-sulfur covalent bond. The carbon-sulfur covalent bond usually has an adsorption peak in a wave number region ranging from 500 to 800 cm⁻¹ in an infrared adsorption spectrum. When the chain transfer agent is incorporated into the latex and the toner made from the latex, the adsorption peak may be changed, for example, to a wave number region of 400 to 4,000 cm⁻¹.

Exemplary chain transfer agents include, but are not limited to, n-C₃₋₁₅ alkylmercaptans, such as, n-propylmercaptan, n-butylmercaptan, n-amylmercaptan, n-hexylmercaptan, n-heptylmercaptan, n-octylmercaptan, n-nonylmercaptan, n-decylmercaptan, and n-dodecylmercaptan; branched alkylmercaptans such as isopropylmercaptan, isobutylmercaptan, s-butylmercaptan, tert-butylmercaptan, cyclohexylmercaptan, tert-hexadecylmercaptan, tert-laurylmercaptan, tert-nonylmercaptan, tert-octylmercaptan, and tert-tetradecylmercaptan; aromatic ring-containing mercaptans such as allylmercaptan, 3-phenylpropylmercaptan, phenylmercaptan, and mercaptotriphenylmethane. As a skilled artisan understands, the terms, “mercaptans,” and, “thiol,” may be used interchangeably to mean C—SH group.

Typical examples of such chain transfer agents also include, but are not limited to, dodecanethiol, butanethiol, isoctyl-3-mercaptopropionate, 2-methyl-5-t-butyl-thiophenol, carbon tetrachloride, carbon tetrabromide and the like.

Based on total weight of the monomers to be polymerized, the chain transfer agent may generally be present in an amount from about 0.1% to about 7%, from about 0.5% to about 6%, from about 1.0% to about 5%, although a transfer agent may be present in greater or lesser amounts.

In various embodiments, a branching agent may optionally be included in the first/second monomer composition to control the branching structure of the target latex. Exemplary branching agents include, but are not limited to, decanediol diacrylate (ADOD) (Shin-Nakamura Co., JP) trimethylolpropane, pentaerythritol, trimellitic acid, pyromellitic acid, and mixtures thereof.

Based on total weight of the monomers to be polymerized, the branching agent may be present in an amount from about 0% to about 2%, from about 0.05% to about 1.0%, from about 0.1% to about 0.8%, although a branching agent may be present in greater or lesser amounts.

In the latex process and toner process of the disclosure, emulsification may be done by any suitable process such as mixing at elevated temperature. For example, the emulsion mixture may be mixed in a homogenizer set at about 200 to about 400 rpm and at a temperature of from about 40° C. to about 80° C. for a period of from about 1 minute to about 20 minutes.

Any type of reactor may be suitably used without restriction. The reactor can include means for stirring the compositions therein. Typically, the reactor can include at least one impeller. For forming the latex and/or toner, the reactor preferably is operated throughout the process such that the impellers can operate at an effective mixing rate of about 10 to about 1,000 rpm.

Following completion of the monomer addition, the latex may be permitted to stabilize by maintaining the conditions for a period of time, for example from about 10 to about 300 minutes, before cooling. Optionally, the latex formed by the above process may be isolated by standard methods known in the art, for example, coagulation, dissolution and precipitation, filtration, washing, drying, or the like.

For adjusting the acid number and hydroxyl number, the following may be used; monovalent acids such as acetic acid and benzoic acid; monohydric alcohols such as cyclohexanol and benzyl alcohol; benzenetricarboxylic acid, naphthalenetricarboxylic acid, and anhydrides and lower alkylesters thereof, trivalent alcohols such as glycerin, trimethylolethane, trimethylolpropane, pentaerythritol, combinations thereof, and the like.

The polyester resins may be synthesized from a combination of components selected from the above-mentioned monomer components, by using conventional known methods. Exemplary methods include the ester exchange method and the direct polycondensation method, which may be used singularly or in a combination thereof. The molar ratio (acid component/alcohol component) when the acid component and alcohol component are reacted, may vary depending on the reaction conditions. The molar ratio can be about 1/1 or as taught herein in direct polycondensation. In the ester exchange method, a monomer, such as, ethylene glycol, neopentyl glycol or cyclohexanedimethanol, which may be distilled away under vacuum, may be used in excess.

In embodiments, the resins may have a glass transition temperature (Tg) of from about 30° C. to about 80° C., from about 35° C. to about 70° C. In embodiments, the resins may have a melt viscosity of from about 10 to about 1,000,000 Pa*S at about 130° C., from about 20 to about 100,000 Pa*S at about 130° C. One, two, or more toner resins may be used. In embodiments where two or more toner resins are used, the toner resins may be in any suitable ratio (e.g., weight ratio) such as for instance about 10% (first resin)/90% (second resin) to about 90% (first resin)/10% (second resin). For example, two or more amorphous resins may be used. In embodiments, a first amorphous resin is a lower molecular weight resin and a second amorphous resin is a higher molecular weight resin.

### Colorants

As the colorant to be added, various known suitable colorants, such as dyes, pigments, mixtures of dyes, mixtures of pigments, mixtures of dyes and pigments, and the like, may be included in the toner. The optional colorant may be included in the toner in an amount of, for example, 0 to about 35% by weight of the toner, from about 1 to about 15 weight % of the toner, from about 3 to about 10% by weight of the toner, although amounts outside those ranges may be utilized. AS examples of suitable colorants, mention may be made of carbon black like REGAL 330®; magnetites, such as Mobay magnetites MO8029™ or MOG8060™, Columbian magnetites; MAPICO BLACKS™ and surface treated magnetites; Pfizer magnetites (CB4799™, CB5300™, CB5600™ or MCX6369™; Bayer magnetites, BAYFERROX 8600™ or 8610™; Northern Pigments magnetites, NP-604™ or NP-608™. Magnox magnetites TMB-100™ or TMB-104™, and the like. As colored pigments, there can be selected cyan, magenta, yellow, red, green, brown, blue or mixtures thereof. Generally, cyan, magenta, or yellow pigments or dyes, or mixtures thereof, as used. The pigment or pigments are generally used as water-based pigment dispersions. Specific examples of pigments include SUNSPERSE 6000, FLEXIVERSE and AQUATONE water based pigment dispersions from SUN Chemicals, HELIOGEN BLUE L6900™, D6840™, D7080™, PYLAM OIL BLUE™, PYLAM OIL YELLOW™ or PIGMENT BLUE 1™ available from Paul Uhlich & Co., Inc. PIGMENT VIOLET 1™, PIGMENT RED 48™, LEMON CHROME YELLOW DCC 1026™, E.D. TOLUIDINE RED™ and BON RED C™ available from Dominion Color Corp., Ltd., Toronto, Calif. NOVAPERM YELLOW FGL™ or HOSTAPERM PINK E™ from sanofi, and CINQUASIA MAGENTA™ available from E. I. DuPont de Nemours & Co., and the like. Generally, colorants that can be selected are black, cyan, magenta or yellow, and mixtures thereof.

Examples of magentas are 2,9-dimethyl-substituted quinacridone and anthraquinone dye identified in the Color Index (CI) as CI 60710, CI Dispersed Red 15, diazo dye identified in the Color Index as CI 26050, CI Solvent Red 19, and the like.

Illustrative examples of cyans include copper tetra(octadecyl sulfonamido) phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like.

Illustrative examples of yellow are diarylide yellow 3,3-dichlorobenzidene acetoacetanilides, a monoazo pigment identified in the Color Index as CI 2700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide and Permanent Yellow FGL.

Colored magnetics, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (sanofi), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF). Lithol Fast Yellow 0991K (BASF), Paliotol Yellow 1840 (BASF), Neopen Yellow (BASF), Novoperm Yellow FG 1 (sanofi), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (sanofi), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann, C A), E. D. Toluidine Red (Aldrich), Lithol Rubine Toner (Paul Uhlich), Lithol Scarlet 4440 (BASF), Bon Red C (Dominion Color Co.), Royal Brilliant Red RD-8192 (Paul Uhlich), Oracet Pin RF (Ciba-Geigy), Paliogen Red 3871K (BASF), Paliogen Red 3340 (BASF), Lithol Fast Scarlet L4300 (BASF), combinations of the foregoing, and the like.

### Wax

The toners of the present disclosure can contain a wax, which can be either a single type of wax or a mixture of two or more different waxes. A single wax can be added to toner formulations, for example, to improve particular toner properties, such as toner particle shape, presence and amount of wax on the toner particle surface, charging and/or fusing characteristics, gloss, stripping, offset properties and the like. Alternatively, a combination of waxes can be added to provide multiple properties to the toner composition.

When included, the wax may be present in an amount of, for example, from about 1 wt % to about 25 wt % of the toner particles, from about 5 wt % to about 20 wt % of the toner particles. The wax can have a melting point of less than about 30° C., less than about 35° C., less than about 40° C.

Waxes that may be selected include waxes having, for example, an Mw of from about 500 to about 20,000, from about 1,000 to about 10,000. Waxes that may be used include, for example, polyolefins, such as, polyethylene, polypropylene, and polybutene waxes such as commercially available from Allied Chemical and Petrolite Corp., for example, POLYWAX™ polyethylene waxes from Baker Petrolite, wax emulsions available from Michaelman, Inc. and the Daniels products Co., EPOLENE N-15™ commercially available from Eastman Chemical Products, Inc., and VISCOL 550-P™, a low weight average molecular weight polypropylene available from Sanyo Kasei K. K.; plant-based waxes, such as, carnauba wax, rice wax, candelilla wax, sumacs wax, and jojoba oil; animal-based waxes, such as, beeswax; mineral-based waxes and petroleum-based waxes, such as, montan wax, ozokerite, ceresin, paraffin wax, microcrystalline wax and Fischer-Tropsch wax; ester waxes obtained from higher fatty acid and higher alcohol, such as, stearyl stearate and behenyl behenate; ester waxes obtained from higher fatty acid and monovalent or multivalent lower alcohol, such as, butyl stearate, propyl oleate, glyceride monostearate, glyceride distearate, and pentaerythritol tetra behenate; ester waxes obtained from higher fatty acid and multivalent alcohol multimers, such as, diethyleneglycol monostearate, dipropyleneglycol distearate, diglyceryl distearate, and triglyceryl tetrastearate; sorbitan higher fatty acid ester waxes, such as, sorbitan monostearate, and cholesterol higher fatty acid ester waxes, such as, cholesteryl stearate. Examples of functionalized waxes that may be used include, for example, amines, amides, for example, AQUA SUPERSLIP 6550™ or SUPERSLIP 6530™ available from Micro Powder Inc., fluorinated waxes, for example, POLYFLUO 190™, POLYFLUO 200™, POLYSILK 19™ or POLYSILK 14™ available from Micro Powder Inc., mixed fluorinated, amide waxes, for example, MICROSPERSION 19™ also available from Micro Powder Inc., imides, esters, quaternary amines, carboxylic acids or acrylic polymer emulsion, for example, JONCRYL 74™, 89™, 130™, 537™ and 538™, all available from S C Johnson Wax, and chlorinated polypropylenes and polyethylenes available from Allied Chemical and Petrolite Corp., and S C Johnson wax. Mixtures and combinations of the foregoing waxes may also be used in embodiments. Waxes may be included as, for example, fuser roll release agents.

### Toner Preparation

The toner particles may be prepared by any method within the purview of one skilled in the art. Although toner particle production is described below with respect to emulsion-aggregation (EA) processes, any suitable method of preparing toner particles may be used, including chemical processes, such as suspension and encapsulation processes disclosed in U.S. Pat. Nos. 5,290,654 and 5,302,486, the disclosure of each of which each hereby is incorporated by reference in entirety. Toner compositions and toner particles may be prepared by aggregation and coalescence processes in which smaller sized resin particles are aggregated to the appropriate toner particle size and then are coalesced to achieve the final toner particle shape and morphology.

Toner compositions may be prepared by EA processes, such as, a process that includes aggregating a mixture of an optional wax and any other desired or required additives, and emulsions including the resins described above, optionally with surfactants as described above, and then coalescing the aggregate mixture. A mixture may be prepared by adding an optional wax or other materials, which may also be optionally in a dispersion(s) including a surfactant, to the emulsions, which may be a mixture of two or more emulsions containing the resin. The pH of the resulting mixture may be adjusted by an acid (i.e., a pH adjustor) such as, for example, acetic acid, nitric acid or the like. In embodiments, the pH of the mixture may be adjusted to from about 2 to about 4.5. Additionally, in embodiments, the mixture may be homogenized. If the mixture is homogenized, homogenization may be accomplished by mixing at about 600 to about 4,000 rpm. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates, such as, polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the T_{g} of the resin.

The aggregating agent may be added to the mixture utilized to form a toner in an amount of, for example, from about 0.1 part per hundred (pph) to about 1 pph, from about 0.25 pph to about 0.75 pph.

The gloss of a toner may be influenced by the amount of retained metal ion, such as AL³⁺, in the particle. The amount of retained metal ion may be further adjusted by the addition of EDTA. The amount of retained metal ion, for example AL³⁺, in toner particles of the present disclosure may be from about 0.1 pph to about 1 pph, from about 0.25 pph to about 0.8 pph.

the present disclosure also provides a melt mixing process to produce low cost and safe crosslinked thermoplastic binder resins for toner compositions which have low fix temperatures and high offset temperatures, and which show minimal or substantially no vinyl offset. In the process, unsaturated base polyester resins or polymers are melt blended, that is, in the molten state under shearing conditions producing substantially uniformly dispersed toner constituents, and which process provides a resin blend and toner product with optimized gloss properties (see, e.g., U.S. Pat. No. 5,556,732, herein incorporated by reference in entirety.

To control aggregation and coalescence of the particles, the aggregating agent may be metered into the mixture over time, for example, the agent may be metered into the mixture over a period of from about 5 to about 240 minutes, from about 30 to about 200 minutes. The addition of the agent may also be done while the mixture is maintained under stirred conditions, from about 50 rpm to about 1,000 rpm, from about 100 rpm to about 500 rpm, and at a temperature that is below the T_{g} of the resin.

### Shell Resin

In embodiments, a shell may be applied to the formed aggregated toner particles. Any resin described above or known as suitable for the core resin may be utilized as the shell resin. The shell resin may be applied to the aggregated particles by any method within the purview of those skilled in the art. In embodiments, the shell resin may be in an emulsion including any surfactant described above or known in the art. The aggregated particles described above may be combined with said emulsion so that the resin forms a shell over the formed aggregates. In embodiments, an amorphous polyester may be utilized to form a shell over the aggregates to form toner particles having a core-shell configuration.

For previous toner particles, having a size of diameter of from about 4 to about 8 μm, from about 5 to about 7 μm, the optimal shell component may be about 26 to about 30% by weight of the toner particles.

Alternatively, a thicker shell may be desirable to provide excellent charging characteristics due to the higher surface area of the toner particle. Thus, the shell resin may be present in an amount of at least about 30% by weight of the toner, in embodiments from about 30% to about 40%, from about 32% to about 38%, from about 34% to about 36%.

A photoinitiator may be included in the shell. Thus, the photoinitiator may be in the core, the shell, or both. The photoinitiator may be present in an amount of from about 1% to about 5% by weight of the toner particles, from about 2% to about 4%.

The particles may be permitted to aggregate until a predetermined desired particle size is obtained. Samples may be taken during the growth process and analyzed, for example with a COULTER COUNTER, for average particle size. The aggregation thus may proceed by maintaining the elevated temperature, or slowly raising the temperature to, for example, from about 40° C. to about 100° C., and holding the mixture at that temperature for a time from about 0.5 hours to about 6 hours, from about hour 1 to about 5 hours, while maintaining stirring, to provide the aggregated particles. The particle size may be about 4 to 8 μm, from about 5 to about 7 μm, from about 6 to about 6.5 μm.

Emulsions may have a solids loading of from about 5% solids by weight to about 20% solids by weight, from about 12% solids to about 17% solids.

Once the desired final size of the toner particles is achieved, the pH of the mixture may be adjusted with a base (i.e., a pH adjustor) to a value of from about 6 to about 10, from about 6.2 to about 7. The adjustment of the pH may freeze, that is, stop, toner growth. The base utilized to stop toner growth may include any suitable base, such as, for example, alkali metal hydroxides, such as, for example, sodium hydroxide, potassium hydroxide, ammonium hydroxide, combinations thereof, and the like. In embodiments, a chelator or buffer may be included, such as, ethylene diamine tetraacetic acid (EDTA) to help adjust the pH to the desired values noted above. The base may be added in amounts from about 2 to about 25% by weight of the mixture, from about 4 to about 10%. The shell can have a higher T_{g} than the aggregated toner particles.

### Coalescence

Following aggregation to the desired particle size, with the formation of a shell as described above, the particles then may be coalesced to the desired final shape, the coalescence being achieved by, for example, heating the mixture to a temperature of from about 55° C. to about 100° C., from about 65° C. to about 75° C., which may be below the melting point of any crystalline resin present to prevent plasticization. Higher or lower temperatures may be used, it being understood that the temperature is a function of the resins used for the binder.

Coalescence may proceed and be accomplished over a period of from about 0.1 to about 9 hours, from about 0.5 to about 4 hours.

After coalescence, the mixture may be cooled to room temperature, such as, from about 20° C. to about 25° C. The cooling may be rapid or slow, as desired. A suitable cooling method may include introducing cold water to a jacket around the reactor. After cooling, the toner particles optionally may be washed with water and then dried. Drying may be accomplished by any suitable method for drying including, for example, freeze drying.

### Additives

In embodiments, the toner particles also may contain other optional additives, as desired or required. For example, the toner may include any known charge additives in amounts of from about 0.1 to about 10 wt %, from about 0.5 to about 7 wt % of the toner. Examples of such charge additives include alkyl pyridinium halides, bisulfates, the charge control additives of U.S. Pat. Nos. 3,944,493, 4,007,293, 4,079,014, 4,394,430 and 4,560,635, the disclosure of each of which hereby is incorporated by reference in entirety, negative charge enhancing additives, such as, aluminum complexes, and the like.

Surface additives can be added to the toner compositions of the present disclosure after washing or drying. Examples of such surface additives include, for example, metal salts, metal salts of fatty acids, colloidal silicas, metal oxides, strontium titanates, mixtures thereof, and the like. Surface additives may be present in an amount of from about 0.1 to about 10 wt %, from about 0.5 to about 7 wt % of the toner. Examples of such additives include those disclosed in U.S. Pat. Nos. 3,590,000, 3,720,617, 3,655,374 and 3,983,045, the disclosure of each of which hereby is incorporated by reference in entirety. Other additives include zinc stearate and AEROSIL R972® available from Degussa. The coated silicas of U.S. Pat. Nos. 6,190,815 and 6,004,714, the disclosure of each of which hereby is incorporated by reference in entirety, also can be present in an amount of from about 0.05 to about 5%, from about 0.1 to about 2% of the toner, which additives can be added during the aggregation or blended into the formed toner product.

The characteristics of the toner particles may be determined by any suitable technique and apparatus. Volume average particle diameter D_{50y}, GSD_{y}, and GSDₐ may be measured by means of a measuring instrument, such as, a Beckman Coulter MULTISIZER 3.

The gloss level of a toner, as measured by, for example, a Gardner device, can be from about 20 gloss units (gu) to about 100 gu, from about 50 gu to about 95 gu.

Toners of the present disclosure may be utilized as ultra low melt (ULM) toners. In embodiments, the dry toner particles, exclusive of external surface additives, may have the following characteristics.
(1) circularity of from about 0.9 to about 1 (measured with, for example, a Sysmex 3000 analyzer), from about 0.95 to about 0.99, from about 0.96 to about 0.98;
(2) T_{g} of from about 45° C. to about 60° C., from about 48° C. to about 55° C.; and
(3) melt flow index (MFI) g/10 min (5 kg/130° C.) of from about 79.0 to about 172.5.

### Carrier Cores

Various suitable solid core materials can be utilized for the carriers and developers of the present disclosure. Characteristics core properties include those that, in embodiments, will enable the toner particles to acquire a positive charge or a negative charge, and carrier cores that will permit desirable flow properties in the developer reservoir present in an electrophotographic imaging apparatus. Other desirable properties of the core include, for example, suitable magnetic characteristics that permit magnetic brush formation in magnetic brush development processes; desirable mechanical aging characteristics; and desirable surface morphology to permit high electrical conductivity of any developer including the carrier and a suitable toner.

Examples of carrier cores that can be utilized include iron and/or steel, such as atomized iron or steel powders available from Hoeganaes Corp. or Pomaton S.p.A (IT); ferrites such as Cu/Zn-ferrite containing, for example, about 11% copper oxide, about 19% zinc oxide and about 70% iron oxide, including those commercially available from D. M. Steward Corp. or Powdertech Corp., Ni/Zn-ferrite available from Powdertech Corp. Sr (strontium)-ferrite, containing, for example about 14% strontium oxide and about 86% iron oxide, commercially available from Powdertech Corp., and Ba-ferrite; magnetites, including those commercially available from, for example, Hoeganaes Corp. (SW); nickel; combinations thereof, and the like. In embodiments, the polymer particles obtained can be used to coat carrier cores of any known type of various known methods, and which carriers are then incorporated with a known toner to form a developer for electrophotographic printing. Other suitable carrier cores are illustrated in, for example, U.S. Pat. Nos. 4,937,166, 4,935,326 and 7,014,971, the disclosure of each of which hereby is incorporated by reference in their entirety, and may include granular zircon, granular silicon, glass, silicon dioxide, combinations thereof, and the like. In embodiments, suitable carrier cores may have an average particle size of, for example, from about 20 μm to about 400 μm in diameter, from about 40 μm to about 200 μm in diameter.

In embodiments, a ferrite may be utilized as the core, including a metal such as iron and at least one additional metal such as copper, zinc, nickel, manganese, magnesium, calcium, lithium, strontium, zirconium, titanium, tantalum, bismuth, sodium, potassium, rubidium, cesium, strontium, barium, yttrium, lanthanum, hafnium, vanadium, niobium, aluminum, gallium, silicon, germanium, antimony, combinations thereof, and the like.

There may be added to the carrier a number of additives, for example, charge enhancing additives, including particulate amine resins, such as melamine, and certain fluoropolymer powders, such as alkyl-amino acrylates and methacrylate,s polyamides, and fluorinated polymers, such as polyvinylidine fluoride and poly(tetrafluoroethylene), and fluoroalkyl methacrylates, such as 2,2,2-trifluoroethyl methacrylate. Other charge enhancing additives which may be utilized include quarternary ammonium salts, including distearyl dimethyl ammonium methyl sulfate (DDAMS), bis[1-[(3,5-disubstituted-2-hydroxyphenyl)azo]-3-(mono-substituted)-2-naphthalenolato(2-)]chromate(1-), ammonium sodium and hydrogen (TRH), cetyl pyridinium chloride (CPC), FANAL PINK® D4830, combinations thereof, and the like, and other effective known charge agents or additives. The charge additive components may be selected in various effective amounts, such as from about 0.5 weight percent to about 20 weight percent, and from about 1 weight percent to about 3 weight percent, based, for example, on the sum of the weights of polymer/copolymer, conductive component, and other charge additive components. The addition of conductive components can act to further increase the negative triboelectric charge imparted to the carrier, and therefore, further increase the negative triboelectric charge imparted to the toner in, for example, an electrophotographic development subsystem.

The carrier particles may be prepared by mixing the carrier core with a polymer of interest in an amount from about 0.05 to about 10% by weight from about 0.01% to about 3% by weight, based on the weight of the coated carrier particles, until adherence thereof to the carrier core by mechanical impaction and/or electrostatic attraction onto the surface of the core particles. The T_{g} of such carrier resin is from about 80° c. to about 100° C., from about 100° C. to about 140° C. from about 80° C. to about 140° C.

Various effective suitable means can be used to apply a polymer of interest to the surface of the carrier core particles, for example, cascade roll mixing, tumbling, milling, shaking, electrostatic powder cloud spraying, fluidized bed, electrostatic disc processing, electrostatic curtain, combinations thereof and the like. The mixture of carrier core particles and polymer and optional additives then may be heated to enable the polymer to melt, to permit flow of the coating material over the surface of the carrier core and to fuse to the carrier core particles. The concentration of the coating material powder particles, and the parameters of the heating may be selected to enable the formation of a continuous film of the coating polymers on the surface of the carrier core, or permit only selected areas of the carrier core to be coated. In embodiments, the carrier with the polymeric powder coating may be heated to a temperature of from about 170° C. to about 280° C., from about 190° C. to about 240° C., for a period of time of, for example, from about 10 min to about 180 min, from about 15 min to about 60 min, to enable the polymer coating to melt and to fuse to the carrier core particles. As in U.S. Pat. No. 6,042,981, the disclosure of which is hereby incorporated by reference in entirety, the carrier coating mixture is fused to the carrier core in either a rotary kiln or by passing through a heated extruder apparatus. The coated carrier particles may then be cooled and thereafter classified to a desired particle size.

In embodiments, the coating coverage encompasses from about 10 to about 100% of the surface of the carrier core. When selected areas of a carrier core remain uncoated or exposed, the carrier particles may posses electrically conductive properties, such as, when the core material is a metal.

In embodiments, carriers of the present disclosure may include a core, in embodiments a ferrite core, having a size of from about 20 μm to about 100 μm, from about 30 μm to about 75 μm (although sizes outside of those ranges may be used), coated with about 0.5% to about 10% by weight, from about 0.7% to about 5% by weight (although amounts outside of those ranges may be obtained), of the polymer coating of the present disclosure, optionally including carbon black.

Alternative methods of coating the carrier of include solution coating processes, which requires a solvent to dissolve the resin mixture. Coating the carrier with the resin mixture as a dry powder has the advantage that no solvent is required for the coating process, thus the coating resin does not need to be soluble in a solvent, and the final coated carrier does not need to be dried to remove the solvent added in the carrier coating process. Solution coating usually requires a coating polymer whose composition and molecular weight properties enable the resin to be soluble in a solvent in the coating process.

Alternative methods of preparing carrier include mixing the polymer resin with magnetic material and optional additives so that the magnetic material is dispersed throughout the resin, rather than as a core of magnetic material coated by a resin. This dispersed mixture is then formed into the final carrier core particle by any method known in the art, including methods of forming synthetic carrier, as described, for example, in U.S. Pat. Nos. 7,754,408, U.S. Pat. No. 4,426,433, U.S. Pat. No. 5,663,027, U.S. Pat. No. 4,565,765 and U.S. Pat. No. 5,629,119, the content of each of which is incorporated by reference in entirety.

### Developers

The toner particles thus formed may be formulated into a developer composition. The toner concentration in the developer may be from about 1% to about 25% by weight of the total weight of the developer, from about 2% to about 15% by weight of the total weight of the developer.

### Imaging

The developer can be utilized for electrophotographic processes, including those disclosed in U.S. Pat. No. 4,295,990, the disclosure of which is hereby incorporated by reference in entirety. Any known type of image development system may be used in an image developing device, including, for example, magnetic brush development, semiconductive magnetic brush development, jumping single-component development, hybrid scavengeless development (HSD) and the like. Those and similar development systems are within the purview of those skilled in the art.

It is envisioned that the developers of the present disclosure may be used in any suitable procedure for forming an image with a developer, including in applications other than xerographic applications.

The developer of the present disclosure may have surface additives affixed to the toner surface, including but not limited to silica.

Utilizing the developers of the present disclosure, images may be formed on substrates, including flexible substrates, having a toner pile height of from about 1 μm to about 6 μm, from about 2 μm to about 4.5 μm, from about 2.5 to about 4.2 μm.

The developer of the present disclosure may be used for a xerographic print protective composition that provides overprint coating properties including, but not limited to, thermal and light stability and smear resistance, such as, in commercial print applications.

### Rational Design

A computer with appropriate software may be used to design carrier resins and/or predict key attributes for resins. Such paradigms, algorithms, programs and the like are known, such as described by Nikitina et al., Journal of Imaging Science and Technology 53(4): 040503, 2009 and herein incorporate by reference in entirety or are available commercially.

A method of designing carrier resins paired with toner as part of an electrophotographic printing process is disclosed including identifying a test polymer and modeling the surface of the polymer; identifying a test toner additive and modeling the surface of the toner additive; determining surface electron properties of the polymer and the toner additive using, for example, a density functional method, where the method determines structure calculations for local and gradient-dependent function; determining the initial structure, optimized structure and electronic properties of adsorbed test polymer complexes on the toner additive; determining geometry optimization convergence for the adsorbed polymer complexes on the toner additive, where the optimization is achieved when the energy, gradient, and displacement are lower than about 2×10⁻⁵ Ha, about 4×10⁻³ Ha/Å, and about 5×10⁻³ Å, respectively; determining the likely direction of charge transfer between the polymer and toner additive by calculating the HOMO and LUMO for the polymer/toner additive complexes; determining Fukui functions for surface electron densities in HOMO and LUMO to describe the active sites of the donor/acceptor complexes in charge transfer; and determining the lowest energy gap for both forward electron transfer and reverse electron transfer, where when the reverse gap is higher than the forward gap for the adsorbed polymer complexes on the toner additive, the negative gap difference is predictive of high negative toner charge in charging of toner resins comprising the polymer/toner additive complexes.

In embodiments, the gap for forward charge transfer of electrons for said monomer is less than about 5.1 (eV), including that the gap for reverse charge transfer of electrons from said toner additive is greater than the forward gap.

Those of skill in the art will recognize that many of the functions and aspects of such a method may be implemented on a computer or computers. The hardware of such computer platforms typically is general purpose in nature, albeit with an appropriate network connection for communication via the intranet, the Internet and/or other data networks.

As known in the data processing and communication arts, each such general purpose computer typically comprises a central processor, an internal communication bus, various types of memory (RAM, ROM, EEPROM, cache memory etc), disk drives or other code and data storage systems, and one or more network interface cards or ports for communication purposes. The computer system also may be coupled to a display and one or more user input devices such as alphanumeric and other keys of a keyboard, a mouse, a trackball, and the like. The display and user input element(s) together form a service-related user interface, for interactive control of the operation of the computer system. The user interface elements may be locally coupled to the computer system, for example in a workstation configuration, or the user interface elements may be remote from the computer and communicate therewith via a network. The elements of such a general purpose computer system also may be combined with or built into routing elements or nodes of the network.

The software functionalities (e.g., many of the operations described above)involve programming of controllers, including executable code as well as associated stored data. The software code is executable by the general purpose computer that functions as the particular computer. In operation, the executable program code and possibly the associated data are stored within the general purpose computer platform. At other times, however, the software may be stored at other locations and/or transported for loading into the appropriate general purpose computer system. Hence, the embodiments involve one or more software products in the form of one or more modules of code carried by at least one machine-readable medium. Execution of such code by a processor of the computer platform enables the platform to implement the system or platform functions, in essentially the manner performed in the embodiments discussed and illustrated herein.

As used herein, terms such as controller or CPU or computer or machine readable medium refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s). Volatile media include dynamic memory, such as main memory of such a computer platform. Physical transmission media include coaxial cables; copper wire and fiber optics, including the wires that comprise a bus within a computer system. Carrier wave transmission media may take the form of electric or electromagnetic signals, or acoustic or light waves, such as, those generated during radio frequency (RF) and infrared (IR) data communications. Common forms of computer-readable media therefore include, for example; a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer may read programming code and/or data. Many of those forms of computer readable media may be involved in carrying one or more sequences of one or more instructions to a processor for execution.

The following Examples are submitted to illustrate embodiments of the present disclosure. The Examples are intended to be illustrative only and are not intended to limit the scope of the present disclosure. Also, parts and percentages are by weight unless otherwise indicated. As used herein, “room temperature,” refers to a temperature of from about 20° c. to about 30° C.

### EXAMPLES

### Example 1

### Silica Charge with Carrier Resins

There are problems in providing high charge with good RH sensitivity of charge to changing environmental conditions for carrier coating resins. For example, polymer resins such as poly(cyclohexyl methacrylate) (PCHMA) could be used as carrier coating resins to provide similar charge as such resins including poly(methyl methacrylate) (PMMA) coated resin, but with improved RH sensitivity.

When 2-(dimethyl amino) ethyl methacrylate (DMAEMA) is included as a comonomer, at up to 1.5% by mole, to the CHMA monomer as a polymer coating for carrier, C-zone toner charge (dry conditions) increased generally with increasing DMAEMA. However, while charge increased in dry conditions in the C-zone, the performance in the A-zone was not as good. As the amount of DMAEMA increased and the C-zone charge increased, the RH ratio (the ratio of C-zone to A-zone charge), generally increased. A suitable RH ratio would have about the same A and C zone charges. However, often, it is not uncommon for the A zone charge to be lower than the C zone charge resulting to a lower RH ratio. Many toners contain silica as a surface additive; and silica is a major charge driver for toner. However, silica is known to be RH sensitive.

It seems that a high carbon-to-oxygen (C/O) ratio in the monomer of the carrier resin improves RH sensitivity, while still providing good charge. For example, increasing the amount of CHMA in copolymers of CHMA and PMMA, where DMAEMA is kept constant at 1% in the copolymer, demonstrates such behavior. Thus, it was desirable to increase the carbon of a resin, for example, by replacing a methyl group in PMMA with a cyclohexyl group in CHMA.

Hence, resins, such as, PMMA, PCHMA and copolymers containing DMAEMA monomer can provide acceptable charge levels with silica, at least under dry conditions. Under high RH conditions, a higher C/O ratio is desired as demonstrated for methacrylates that contain a cyclic hydrocarbon group, such as, a cyclohexyl group as in PCHMA.

To provide functional specification for the carrier coating resin materials that will provide high negative charge to silica on a toner surface and to provide a description of chemical functionality that will in addition provide an improved RH sensitivity, computer modeling was used to understand and define properties that are important, inter alia, to design (and predict properties of) new materials that have both high charge and good RH sensitivity.

### Modelling

For all substituted methacrylates, a trimer was used to represent the polymer to be examined. To distinguish possible effects of C (carbon) rich and O (oxygen) rich functional groups (alkyl/aromatic and acyl) in the polymer, all three acyl groups were designed to coordinate to the same side.

To mimic the surface hydroxyl group of the silica model, a one layer cylinder-like silica model was used to design the surface treated silicas with the formula, Si₁₂O₃₂H₁₆. In the model, all silicas were in tetrahedral geometry and connected by oxygen. The edge of the cylinder was terminated by two hydroxyl groups to represent the geminal silanols [Si(OH)₂], which are typical on the surface of β-cristobalite, identified experimentally on the amorphous silica surface as one of the two types of surface hydroxyl group of untreated silica (see, e.g., Leonardelli, et al., J Am Chem Soc (1992) 114:6412; Vigné-Maeder and Sautet, J Phys Chem (1997) 101(41):8197, herein incorporated by reference in entirety). All calculations were performed with the DMol3 module from the Accelrys Materials Studio 4.2 commercial software package. Density functional theory (DFT) was used for the study of surface electronic properties of all models and the coupled toner/carrier complexes.

Recent extension of the DMol3 density functional method is designed for electronic structure calculations of local and gradient-dependent function, depending on the accuracy needed. In the present modeling example, Perdew's 91 generalized gradient approximations (PW91PW91) were employed as the density functional method. For basis sets, a double numerical basis set with d-polarization functions (DND) were used for all calculations. For different basis set types, DND performs better than a Gaussian-type basis set of the same size, which is 6-31G*. The DND numerical solutions can give highly accurate DFT solutions for the separated atoms limit for molecular and solids calculations.

The initial structure, optimized structure and electronic properties of adsorbed polymer complexes on the silica were studied. The geometry optimization convergence was achieved when the energy, gradient, and displacement were lower than 2×10⁻⁵ Ha, 4×10⁻³ Ha/Å, and 5×10⁻³ Å, respectively. Ha is the Hartree atomic units (au), where 1 au=4.359×10⁻¹⁸ Joules. The calculations of HOMO-LUMO orbitals were performed to understand the direction of charge transfer of the above models and to identify the most essential factor that could effect electron transfer in the complex models.

Electron transfer active sites on different materials are crucial to triboelectric charge since they are the root and destination of electron transfer and the relative ability of donating and accepting electrons will directly determine the triboelectric charge properties of certain toner/charger pairs. Generated surface electron densities in HOMO and LUMO, and softness as given by the Fukui function, which enables charge transfer, are used to describe the active sites of the donor-acceptor complex in the charge transfer. Fukui functions were calculated for +0.1 |e| and −0.1 |e| charges.

To further explore the reverse gap and the forward gap of charge transfer, the excited orbitals for the above systems were studied. Generally, 10 levels of orbital above (M+9) and below (n−9), the Fermi levels were calculated. The lowest energy gap for both forward electron transfer and reverse electron transfer were collected from the sets of twenty orbitals. The calculation errors of the energy gaps were evaluated by comparing the forward and reverse electron transfer barrier of DMAEMA dimer and trimer/silica complexes.

### Results

The key attributes for high negative toner charge from modeling are as follows:
1) the gap for the forward charge transfer needs to be low;
2) the reverse gap should be higher than the forward gap (a negative gap difference, subtracting (1) and (2));
3) the resin has a high C/O ratio monomer;
4) the T_{g} of the resin must be relatively high; and
5) the water adsorption at the charging site must be low.
   Attributes (1) and (2): The gap for the forward charge transfer needs to be low and the reverse gap should be higher than the forward gap (negative gap difference.

To model electron transfer from the carrier coating resin to the silica toner additive, a carrier resin silica complex was studied, comprising a trimer unit of the carrier resin and a silica surface model. Note, in the case of the CHMA-DMAEMA trimer, because there are two monomers and 3 units, the structure modeled consisted of two CHMA units and one DMAEMA unit. That is a high concentration of DMAEMA, which, in experimental polymers usually is present at less than 2%. That will have an effect on the predicted energy gap.

It is art recognized that in the usual intramolecular electron transfer, within a single material, the adsorption of sufficient energy from a photon or collision or thermal energy can result in transfer of an electron from the HOMO to the LUMO. Since the electron and hole (left when the electron leaves the HOMO) are both on the same molecule, there is not net charge on the molecule. The size of the energy gap determines the amount of energy required to transfer the electron between the orbitals. Thus, both the carrier resin, for example, and toner additive, before each comes in contact with the other, has a HOMO and a LUMO and an associated gap. It should be noted that there are also potentially other energy levels above the LUMO (known as LUMO+1, LUMO+2, etc. of increasing energy) and below HOMO (known as HOMO−1, HOMO−2, etc. of decreasing energy). So, in general it is possible to transfer an electron from a HOMO−n to a LUMO+m, where n,m≧0 within a material. Note HOMOₙ=0 is usually written as HOMO and LUMOm=0 as LUMO for simplicity.

From the computer modeling, it has been shown that on contact of two materials, such as, between the toner additive and the carrier, a number of different possibilities arise for the location of HOMO−n and the LUMO+m, and thus the result of charge transfer has a number of different possibilities. The contact of the two materials may result in the HOMO−n being located on the carrier resin and LUMO+m on the toner additive. In that situation, the electron transfer will charge the carrier resin positive and the toner additive negative (desired transfer for negative charging toner). On the other hand, if the LUMO+m is located on the carrier resin and the HOMO−n is on the toner additive, the electron transfer will charge the toner additive positive and the carrier resin negative (undesired transfer for negative charging toner). Of course, the HOMO and LUMO may be located on just one molecule or could be partially on both molecules. The disposition of the frontier molecular orbitals that results is a consequence of the properties of the two materials and the interaction therebetween, that interaction also depending on the orientation of the two molecules in contact. In a bulk sample of material, different orientations of the molecules in contact will be obtained randomly. So, the overall charge transferred is the sum of the different processes. Fortunately, the important processes for charge transfer will be that of the lowest energy, so in the collection of the modeling data, the process is to look at different orientations of contact and to identify the lowest energy gap for the forward charge transfer desired (e.g., negative toner charge) and lowest energy gap for reverse charge transfer (i.e., positive toner charge).

Thus, modeling shows that for high negative toner charge in the charging of toners with silica and carriers with a polymeric resin coating, there are two key attributes:
1) the gap for the forward charge transfer needs to be low and
2) the reverse gap should be higher than the forward gap (a negative gap difference, subtracting (1) from (2)).

Table 1 below shows the modeling data for electron charge transfer to silica (desirable) to electron charge transfer to a polymer (not desirable) for a number of different coating materials.

TABLE 1
Modelling Data for Charge Transfer

| | Model Data | Model Data | Model Data | | | | |
|---|---|---|---|---|---|---|---|
| | Charge | Charge | Positive | | | | |
| | Transfer | Transfer | Carrier | | | | |
| | Polymer to | Silica to | Charge | Measured | Calculated | Charging | |
| | Silica (eV) | polymer (eV) | Prediction | Charging | C/O Ratio | RH Ratio | T_{g} (° C.) |
| MMA | 4.79 | 6.24 | Good | Good | 2.5 | Poor | 100 |
| CHMA | 4.67 | 6.51 | Good | Good | 5.0 | Good | 100 |
| CHMA/ | 4.28 | 6.25 | Good, | Good | ≈5 | Worse than | ≈100 if |
| DMAEMA | | | increased | | | CHMA as | DMAEMA |
| | | | | | | more | content is |
| | | | | | | DMAEMA | low, 1-2% |
| | | | | | | added | |
| DMAEMA | 3.73 | 5.23 | Good, | | 4 | | 18 |
| | | | increased | | | | |
| HMA | 5.26 | >6.00 | Slightly | | 5 | | −3 |
| | | | lower | | | | |
| i-butylMA | 4.90 | 6.49 | Good | | 4 | | 53 |
| t-butylMA | 5.23 | 6.26 | Slightly | Good | 4 | Good | 118 |
| | | | lower | | | | |
| t-hexylMA | 4.61 | 6.51 | Good | | 5 | | |

Thus, the modeling data show that PMMA, PCHMA and DMAEMA/PCHMA have good high charging, as all have a charge transfer gap for forward transfer that is about equal or lower than that for PMMA. In all cases, the energy for reverse transfer is higher, and thus not favored.

The last four entries for the modeling data demonstrate that polymers of i-butylMA have nearly the same forward energy gap as do MMA polymers, hexyl methacrylate (HMA) and t-butyl methacrylate (t-butyl MA) have somewhat higher forward energy gaps than does MMA, while t-hexyl methacrylate (THMA) has an even lower forward energy gap than do PMMA and CHMA. The calculation error for the modeling is shown to be ≈0.045 eV (the error mostly arising from the size difference among polymer trimer models). For all four of the latter materials, the forward energy gap is much lower than the reverse energy gap, and thus, positive carrier charge (negative toner charge) from the lower energy forward electron is expected, compared to the unfavorable negative carrier charge (positive toner charge) from the higher energy reverse electron transfer. It should also be noted that a small amount of DMAEMA can be added to any of the polymers to reduce the gap for forward electron transfer to the silica toner additive. DMAEMA does however, increase the RH sensitivity of the charge because of the polar nitrogen atom which increases water adsorption at the charge site (which is the N atom) for that molecule, so the amount of DMAEMA that can be added will be small. Overall, from the modeling data, all of the materials would provide reasonable charging though clearly the longer chain tertiary hexyl has the lowest gap and thus the best charging.

### Example 2

### Synthesis of CHMA Resin Latex

A latex emulsion including polymer particles generated by emulsion polymerization was prepared as follows. An aqueous surfactant solution including about 0.75 g sodium lauryl sulfate (an aniomic emulsifier) and about 380 g of dionized water (DIW) was prepared by combining the two in a beaker and mixing for about 10 minutes. The aqueous surfactant solution was then transferred into a reactor. The reactor was continuously purged with nitrogen while being stirred at about 450 revolutions per minute (rpm). Separately, about 0.47 g of ammonium persulfate initiator was dissolved in about 4 g of DIW water to form an initiator solution.

In a separate container, about 112 g of cyclohexylmethacrylate were added to a beaker to form a monomer solution.

About 10% by weight of the monomer solution was added to the aqueous surfactant mixture as a seed. The reactor was then heated to about 65° C. at a controlled rate of about 1° C./minute. Once the temperature of the reactor reached about 65° C., the initiator solution was added into the reactor and stirred for 40 minutes, after which the rest of the monomer solution was continuously fed into the reactor using a metering pump at a rate of about 0.8% by weight/minute.

Once all the monomer solution was charged into the main reactor, the temperature was held at about 65° C. for an additional 2 hours to complete the reaction. Full cooling was then applied and the reactor temperature was reduced to about 35° C. The product was then collected in a container and dried to a powder form using an FTS Systems freeze drier. The final latex size as determined using a Nanotrac Particle Size Analyzer (Microtrac), was 89 nm.

### Example 3

### Synthesis of TBMA Resin Latex

A latex emulsion was prepared and dried in the same manner as in Example 2 except that the monomer solution was composed of 94.8 g t-butyl methacrylate (Scientific Polymer Products, Inc., Ontario, N.Y.). The final latex size was 95 nm.

### Example 4

### Synthesis of CHMA and DMAEMA Resin Latex

A latex emulsion was prepared and dried in the same manner as in Example 2 except that the monomer also contained 1.05 g dimethyl-amino ethylmethacrylate. The final latex size was 103 nm.

### Example 5

### Preparation and Analysis of Carrier

Carrier was prepared as follows. About 120 g of a 35 μm ferrite core were placed into a 250 ml polyethylene bottle. About 0.912 g of the dried powder polymer latex was added thereto. The bottle was then sealed and loaded into a C-zone Turbula mixer. The Turbula mixer was run for about 45 minutes to disperse the powder onto the carrier core particles.

Next, a Haake mixer was setup with the following conditions: set temperature 200° C.; 30 minutes batch time; 30 rpm with high shear rotors. After the Haake mixer reached the operating temperature, the mixer rotation was started and the blend was transferred from the Turbula into the Haake mixer. After about 45 minutes, the carrier was discharged from the mixer and sieved through a 45 μm screen.

Developers were prepared with the various carriers listed in Table 2 by combining them with a Xerox 700 Digital Color Press cyan toner. The concentration of the toner was about 5 parts per hundred (pph). Developers were conditioned overnight in the high temperature, high humidity A-zone at 28° C./85% RH and the low temperature, low humidity C-zone at 12° C./15% RH, and then sealed and agitated for 60 minutes using a Turbula mixer.

Charging characteristics were obtained as q/m values in μC/g using the total charge blow-off method and by a charge spectrograph using a 100 V/cm field as q/d values in mm displacement. The q/d values can be converted from mm displacement to fC/μm by multiplying the value in mm by 0.092. The charging results are set forth below in Table 2.

The t-butyl methacrylate carrier has higher charge and better RH sensitivity than a comparative carrier coated with cyclohexyl methacrylate. To increase the charge of the cyclohexyl methacrylate, 1% DMAEMA was added as a comonomer which increased A-zone charge to near equal to that of t-butyl methacrylate. However, C-zone charge was higher than that with t-butyl methacrylate and thus the RH ratio for both q/d and q/m decreased as compared to cyclohexyl methacrylate.

Thus, the t-butyl methacrylate provides both a higher charge and an improved RH ratio, which is desirable for a number of reasons. First, such a compound provides flexibility to the design of the carrier as high charge is possible for toner materials that may not have high enough charge with current carriers. Also, the carrier used has no additive added to the coating to increase conductivity, such additives generally decrease charge. Also, another method to increase conductivity of the carrier as desired is to only partially coat the surface of the core, which is typically somewhat conductive. That will reduce the charge as not all the surface of the carrier has the high charging coating. Further, there are many comonomers or other polymers that could be added to reduce the charge, if desired. For example, the polymers of cyclohexyl methacrylate and t-butyl methacrylate could be combined in the coating, or a copolymer could be made, in various ratios. That would enable producing charge of varying levels, all with good RH sensitivity, unlike as observed with the addition of the DMAEMA. The higher RH ratio with t-butyl methacrylate for both q/d and q/m is anticipated to result in improved latitude for performance in an electrophotographic printer, as is known in the art, a q/d that is too low in the A-zone results in more background and dusting of the toner, while a high q/m in the C-zone results in poor toner image development and lighter images on the print. Thus, a better RH ratio increase the range for good dark images and no background. The overall charge level can be varied as desired by the methods described above,

TABLE 2
Charge Performance for t-Butyl Methacrylate Coated Carrier

| | A-zone | | C-zone | | RH ratio | |
|---|---|---|---|---|---|---|
| | q/d | q/m | q/d | q/m | q/d | q/m |
| Cyclohexyl methacrylate | 5.6 | 28.0 | 12.0 | 48.8 | 0.47 | 0.57 |
| Cyclohexyl methacrylate + | 9.5 | 41.9 | 23.0 | 93.8 | 0.41 | 0.45 |
| 1% DMAEMA | | | | | | |
| t-butyl methacrylate | 8.8 | 42.8 | 16.7 | 64.8 | 0.53 | 0.66 |

### Attribute (3): Carbon to Oxygen Ratio

The MMA C/O ratio is low at 2.5 and has a poor RH sensitivity. CHMA has a C/O ratio of 5, and thus has an improved RH ratio. DMAEMA has a C/O ratio of 4, slightly less than CHMA, but sill much better than MMA. The C/O ratio of the monomer/polymer is an important property related to water adsorption; the higher the C/O ratio, the lower the overall average water adsorption by the polymer, and the less effect high RH will have on charge. At the same RH, the RH of the polymer will contain less water, thus improving charge at high RH. Hexyl methacrylate and tertiary-hexyl methacrylate maintain a high C/O ratio of 5, t-butyl methacrylate has a high C/O of 4. Thus, linear, iso-alkyl and tertiary alkyl methacrylates HMA, i-butylMA, t-butylMA and THMA all provide reasonable RH sensitivity, where longer hexyl chains are better.

### Attribute (4): T_{g} of the Resin

It is desirable to have a longer alkyl chain on the methacrylate monomer to improve the C/O ratio to reduce overall water adsorption. However, longer alkyl chains impact the T_{g} of the resin. In the carrier powder coating process, the T_{g} must be low enough to coat the carrier at elevated temperature (200° C. is a typical coating temperature), but high enough so that the resin does not flow under normal transportation and shipping temperatures, nor flow under the conditions encountered in the printer when running. Since the developer can potentially reach 55-60° C., the Tg should be higher. PMMA and CHMA have a high T_{g} of 100° C. Linear alkyl methacrylates with longer chains, and thus higher C/O ratios, have low T_{g}, for methyacrylates, methyl is 100° C., ethyl, 65° C., butyl 20° C., and hexyl, −3° C. Clearly, for a usable C/O Ratio, above at least 4 or 5, the T_{g} is too low. With branching and creating amore compact and symmetrical substituent, the T_{g} increases. Thus, isobutyl increases to 53° C., from 20° C. with the linear butyl, while t-butyl is better at 118° C. There is no experimental value of T_{g} for tertiary hexyl methacrylate, but it is expected to be close to 100° C. Thus, tertiary alkyl substituents are desirable due to high C/O ratio combined with high T_{g}. Note, some acrylates will be unsuitable because of a lower T_{g}. For example, t-butyl acrylate is −69° C., much too low in T_{g}. Finally, DMAEMA alone is unsuitable, with a T_{g} of 18° C. However, DMAEMA is not strongly positively charging (as shown by the very low energy gap), and typically less than 1 to 2% of the polymer can be DMAEMA, although with those small amounts, DMAEMA does not impact overall T_{g}, although there may be local pertubations with regional softening.

### Attribute (5): Water Adsorption at the Charging Site

The C/O ratio provides an overall measure of the water adsorption by the polymer. However, the location of the water adsorption also is important.

The actual charging site, the location of the HOMO for acrylate polymers likely is the carbonyl (C═O) group. The polar carbonyl group is a favorable location for water adsorption. In the modeling of the water-polymer-silica complex for PMMA, the water actually becomes the site of the HOMO, which is no longer on the carrier surface as the mobile water molecule can provide a path for dissipation of the charge. Thus, the predicted structure for water adsorption on the C═O is the one that provides the most bulky groups to block the approach of water, such as, tertiary structures, such as, t-butyl and t-hexyl methacrylates.

Fukui (−) functions (which show where the positive charge is located) show that the positive charge on the carbonyl group is much more exposed on PMMA, which only has small methyl groups, as compared to the secondary carbon cyclohexyl group, or especially the tertiary carbon t-hexyl or t-butyl groups, calculation of the Fukui function is described, for example, in, Ayers et al., in, “Chemical reactivity theory: a density functional view,” Chatteraj, ed., Chap. 18, pp. 255-267, CRC Press 2009. Thus, the bulkier substituent is expected to reduce the probability of water adsorption on the surface with high RH, thus improving RH sensitivity. Of course, as already pointed out, the higher C/O ratio of the bulky groups also improves RH sensitivity.

A summary of the carrier coating requirements established from the modeling is shown in Table 3.

TABLE 3
Summary of Carrier Coating Requirements.

| | | Calculated | | | |
|---|---|---|---|---|---|
| | | C/O Ratio | Bulky group | | |
| | Charge | for reduced | blocking water | | |
| | Level | water | adsorption at | | |
| | based | adsorption | HOMO | | |
| | on | and good | (carbonyl) | | Overall |
| | Modeling | RH | for good RH | | Perform- |
| | or Data | sensitivity | sensitivity | T_{g} | ance |
| MMA | Good | Poor | Poor: primary C | Good | Poor |
| CHMA | Good | Good | Okay: secondary C | Good | Good |
| CHMA/ | Very | Good | Poor: primary C | Good | Acceptable |
| DMAEMA | good | | | | |
| DMAEMA | Very | Okay | Poor: primary C | Poor | Poor |
| | good | | | | |
| HMA | Okay | Good | Poor: primary C | Poor | Poor |
| i-butylMA | Good | Okay | Okay: secondary C | Poor | Poor |
| t-butylMA | Okay | Okay | Good: tertiary | Good | Good |
| | | | bulky C | | |
| t-hexylMA | Good | Good | Good: tertiary | Good | Best |
| | | | bulky C | | |

It will be appreciated that the above-disclosed and other features and functions, or alternatives thereof, may be desirably combined into many other different systems or applications. Also various presently unforeseen or unanticipated alternatives, modifications, variations or improvements therein may be subsequently made by those skilled in the art, which are also intended to be encompassed by the following claims. Unless specifically recited in a claim, steps or components of claims should not be implied or imported from the specification or any other claims as to any particular order, number, position, size, shape, angle, color or material.

All references cited herein are herein incorporated by reference in their entireties.

We claim:

1. A carrier composition comprising a polymer coating resin comprised of polymer derived from at least one acrylate monomer comprising a bulky tertiary carbon group, wherein said monomer optionally has a carbon:oxygen (C/O) ratio of at least 4 and optionally a conductive material; and a core, wherein said core optionally is magnetic.

2. The carrier composition of claim 1, wherein said acrylate has a T_{g} of from about 80° C. to about 140° C.

3. The carrier composition of claim 2, wherein said acrylate monomer comprises a methyacrylate.

4. The carrier composition of claim 1, wherein said monomer is selected from the group of tertiary butyl methacrylate, tertiary pentyl methacrylate, tertiary hexyl methacrylate, tertiary heptyl methacrylate, tertiary octyl methacrylate, tertiary nonyl methacrylate and tertiary decyl methacrylate.

5. The carrier composition of claim 1, wherein the coating resin further comprises a secondary amino acrylate monomer.

6. The carrier composition of claim 1, wherein the coating resin further comprises cyclohexyl methacrylate.

7. The carrier composition of claim 5, wherein the secondary amino acrylate monomer is selected from the group consisting of dimethylaminoethyl methacrylate, diethylaminoethyl methacrylate and diethylaminopropyl methacrylate.

8. The carrier composition of claim 1, wherein the polymeric coating comprises a copolymer comprising a methacyrlate comprising a bulky tertiary carbon group and an acidic acrylate monomer selected from the group consisting of acrylic acid, methacrylic acid, β-carboxyethyl acrylate and combinations thereof.

9. The carrier composition of claim 1, where the acidic acrylate monomer is present in an amount of from about 0.1% by weight to about 5% by weight of the copolymer.

10. The carrier composition of claim 1, wherein said core comprises a ferrite and at least one additional metal selected from the group consisting of copper, zinc, nickel, manganese, magnesium, calcium, lithium, strontium, zirconium, titanium, tantalum, bismuth, sodium, potassium, rubidium, cesium, strontium, barium, yttrium, lanthanum, hafnium, vanadium, niobium, aluminum, gallium, silicon, germanium, antimony and combinations thereof.

11. The carrier composition of claim 1, wherein said polymeric coating has a number average molecular weight of from about 60,000to about 400,000, a weight average molecular weight of from about 200,000 to about 800,000, and a glass transition temperature of from about 85° c. to about 140° C.

12. The carrier composition of claim 1, wherein said conductive material comprises a colorant.

13. The carrier composition of claim 12, wherein said colorant comprises a black colorant.

14. A developer comprising the carrier composition of claim 1 and a toner, wherein said toner comprises at least one silica surface additive.

15. The developer of claim 14, wherein the energy gap for forward charge transfer of an electron from said polymer to said toner additive is lower than the energy gap for reverse charge transfer of an electron from said toner additive to said polymer.

16. The developer of claim 14, wherein said polymer comprises a methacrylate.

17. The developer of claim 16, wherein said methacrylate is selected from the group of tertiary butyl methacrylate, tertiary pentyl methacrylate, tertiary hexyl methacrylate, tertiary heptyl methacrylate, tertiary octyl methacrylate, tertiary nonyl methacrylate and tertiary decyl methacrylate.

18. The developer of claim 14, wherein the carrier further comprises a secondary amino acrylate monomer.

19. The developer of claim 18, wherein the secondary amino acrylate monomer is selected from the group consisting of dimethylaminoethyl methacrylate, diethylaminoethyl methacrylate, and diethylaminopropyl methacrylate.

20. The developer of claim 14, wherein the toner comprises an emulsion aggregation toner.
